(19) United States
(12) Patent Application Publication
(10) Pub. No.: US 2007/0223748 A1
(43) Pub. Date: Sep. 27, 2007

(54) Glasses with a music sounding device

(76) Inventor: Ching-Hsiang Wang, Tainan City (TW)

Correspondence Address: Ching-Hsiang WANG, P.O. BOX 90, Tainan City, 70499, TW

(21) Appl. No.: 11/372,005

(22) Filed: Mar. 10, 2006

(51) Int. Cl. H04R 5/02; H04R 9/06

(52) U.S. Cl. 381/301; 381/333; 381/388

(57) ABSTRACT

A pair of glasses with a music sounding device includes a pair of glasses and a music sounding device installed in a chamber of two temples of the glasses and a pair of earphones connected with the music sounding device composed of an electric circuit board and a power circuit board. The electric circuit board has an IC, a push button circuit, an indicating lamp circuit, a USB jack, and a memory. The earphones and a power wire hidden in the bar of the glasses are connected the electric circuit board with the power circuit board. In using, a wearer presses a push button on a cap of one chamber to start the music sounding device to send music signal to the two earphones worn in the ears of the wearer. Music programs are at first loaded from a computer into the memory by means of a USB line.

### BACKGROUND OF THE INVENTION

1. Field of the Invention

This invention relates to a pair of glasses with a music sounding device, particularly to one provided with a music sounding device in two chamber formed in two temples for a wearer of the glasses to listen to music through earphones by pressing a push button closed on one of the chambers.

2. Description of the Prior Art

Glasses are commonly used for seeing things clearly or reading or shading strong sunlight, with no other objective. But in modern life, walkmans are widely used, especially the young always like to carry a music sounding device such as MP3, iPOD, etc, with earphones connected with the device. Though such a device is convenient to carry around, but the wires connecting the earphones with the device body may often tangle or be pulled accidentally by an exterior matter or a hand of a user, with the earphones snapped off, causing an embarrassment to the user.

### SUMMARY OF THE INVENTION

The Purpose of the invention is to offer a pair of glasses with a music sounding device convenient for listening to music for a user.

The feature of the invention is a music sounding device installed in a chamber formed respectively in two temples of the glasses, and the music sounding device is composed of an electric circuit board, a power circuit board. The electric circuit board is provided with an IC, a push button circuit board, an indicating lamp circuit, a jack for UBS, and a memory, Those components are connected with wires with a power source, with earphones removably connected with the electric circuit board on a first temple, and the push button protruding out of a cap on the chamber of the first temple, with the power circuit board fitted in the chamber of a second temple. Then a wearer of the glasses can push the push button to turn on and off the music sounding device for listening music through the earphones, without causing the wires of the earphones to be entangles. The music programs recorded in the memory is beforehand loaded from a computer by means of a USB line.

### BRIEF DESCRIPTION OF DRAWINGS

This invention will be better understood by referring to the accompanying drawings, wherein:

FIG. 1 is an exploded perspective view of a pair of glasses with a music sounding device in the present invention;

FIG. 2 is a perspective view of the pair of glasses with a music sounding device in the present invention;

FIG. 3 is a perspective view of the pair of glasses with a music sounding device connected with a SUB line in the present invention;

FIG. 4 is a perspective view of the pair of glasses with a music sounding device in the present invention, showing it worn on a person for listening music; and,

FIG. 5 is a block diagram of an electric circuit board of the present invention.

### DETAILED DESCRIPTION OF THE PREFERRED EMBODIMENT

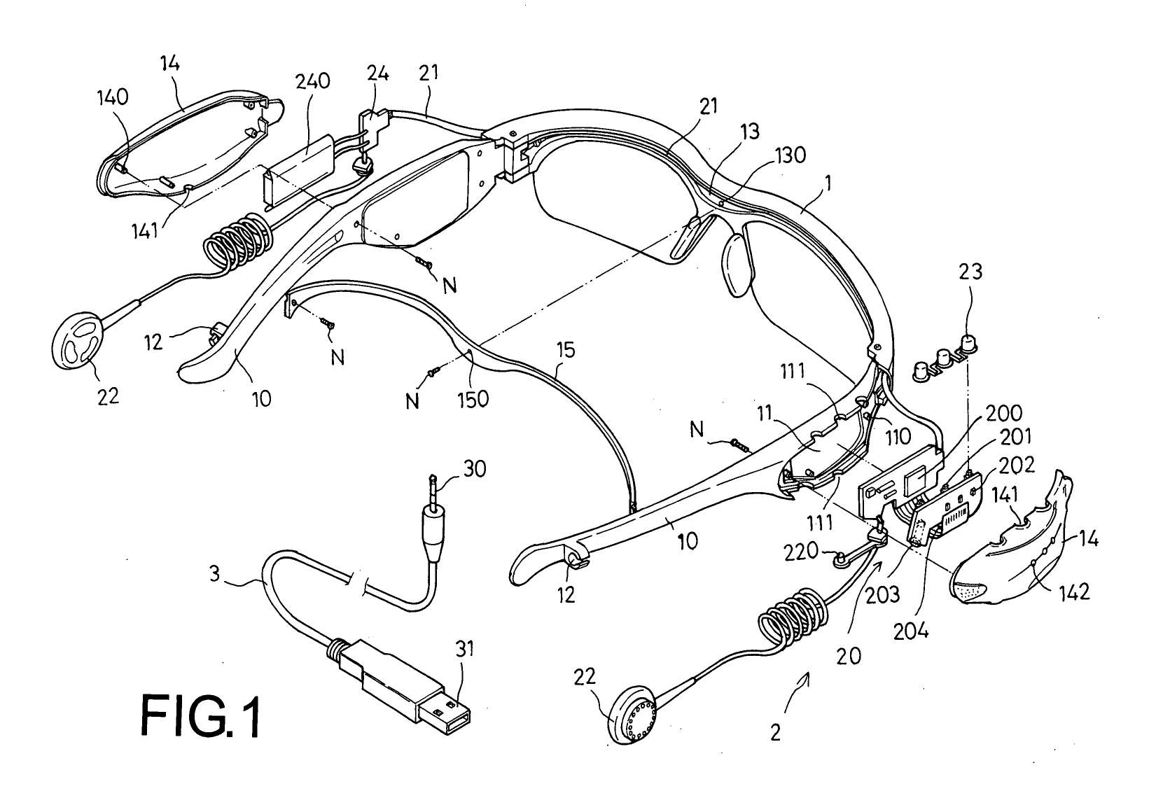

A preferred embodiment of a pair of glasses with a music sounding device in the present invention, as shown in FIG. 1, includes a pair of glasses and a music sounding device 2, and the glasses are provided with two temples 10 respectively provided with a chamber 11 opening outward, plural threaded rods 110 fixed to pass through the bottom wall of the chamber 11, plural notches formed spaced apart in an upper edge and a lower edge of the chamber 11. Each temple has a fitting hole 12 formed in a rear end facing outward, and a bar positioned on two lenses is provided with an elongate groove 13 extending to reach each chamber 11 of the two temples 10, with a threaded hole 130 bored in a center portion of the bar under the elongate groove 12. Further, a caps 14 is provided to cover up each of the two chambers 11 respectively, having plural rods 140 laterally fixed on an inner wall to align to the threaded rods 110 of each chamber 11 for a screw (N) to engage with so as to keep the cap 14 closed on the chamber 1. Each cap 14 is further provided with plural notches 141 spaced apart around a circumference and an indicating lamp 142 fixed in the center portion. Further, an elongate strip 15 fitted tightly in the elongate groove 13 with a screw (N) engaging in both a threaded hole 150 and the threaded hole 130 of the elongate strip 13.

The music sounding device 2 is installed in the chambers 11, composed of an electric circuit board 20 and a power circuit board 24.

The electric circuit board 20 installed in the chamber of a first temple 10 is provided with an IC 200, a push button circuit 201, an indicating lamp circuit 202, a jack 203 for a USB line, and a memory 204. A power line 21 is connected between the electric circuit board 20 and the power circuit board 24 contained in the chamber 11 of a second temple, extending in the elongate groove 13 and reaching the two chambers 11 with two ends. An earphone 22 is connected with a rear side of the electric circuit board 20, having an plug 220 connected with an outer end of the earphone wire and able to be fitted in the insert hole 12 of the temple 10 for holding the earphone 22, when not to be used.

Further, plural push buttons 23 are provided in the electric circuit board 20 to correspond to the push button circuit 201, for turning on and off the music sounding device 2 and adjusting the volume of the music sound.

Next, the power circuit board 24 is installed in the chamber 11 of the second temples 10, having its front side connected with the wire of the music sounding device 2, and its rear side connected with a battery 240 and an earphone 22.

Further, in order to load music programs from a computer into the memory of the music sounding device 2, a USB line 3 is additionally provided, having an plug 30 at one end and another plug 31 at the other end, and the plug 30 can insert in a jack 203 of the music sounding device 2, with the other plug 31 to be inserted in a USB jack of a computer.

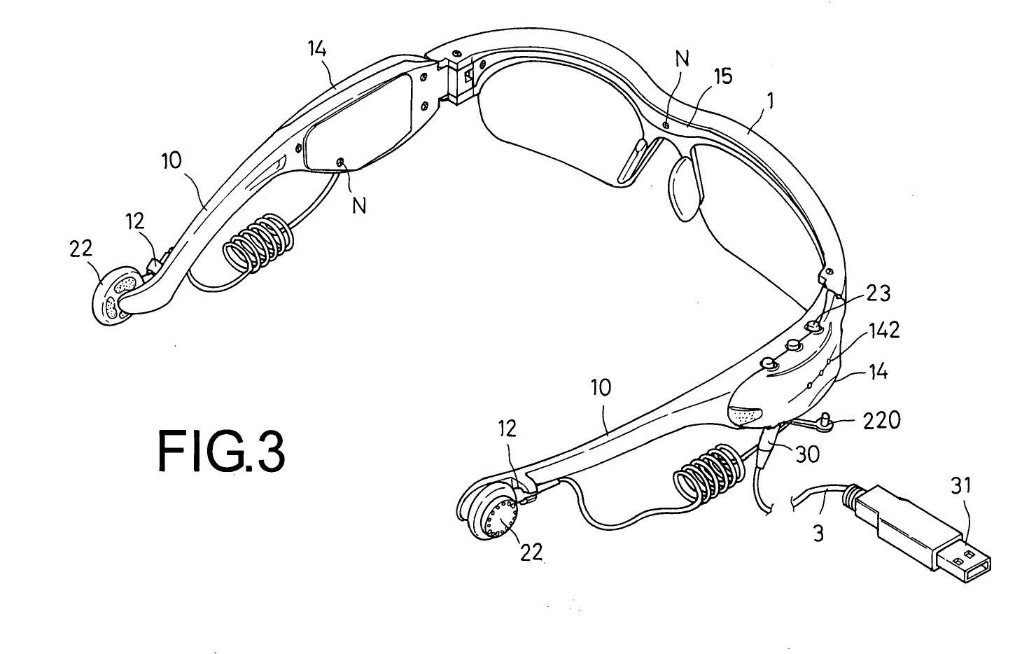

In assembling, as shown in FIGS. 1, 2 and 3, the electric circuit board 20 of the music sounding device 2 is installed in the chambers 11 of the first temple 10 of glasses 1, and the push button 23 is fixed on the electric circuit board 20 facing just the push button circuit 201. Then the cap 14 is closed on that chamber 11 and fastened with the screw (N), and the first plug 220 of the earphone 22 is inserted in the jack 203 of the music sounding device. Next, the power circuit board 24 and the battery 240 are installed in the chamber 11 of the second temple of the glasses 1, and then the cap 14 is closed on that chamber 11 and fastened with the screw (N), with the plug 220 of the earphone 22 is inserted in the insert hole 12 of the temple 10, with the elongate strip 15 placed in the elongate groove 13 and fastened with the screw (N), finishing assembly of the pair of glasses with a music sounding device.

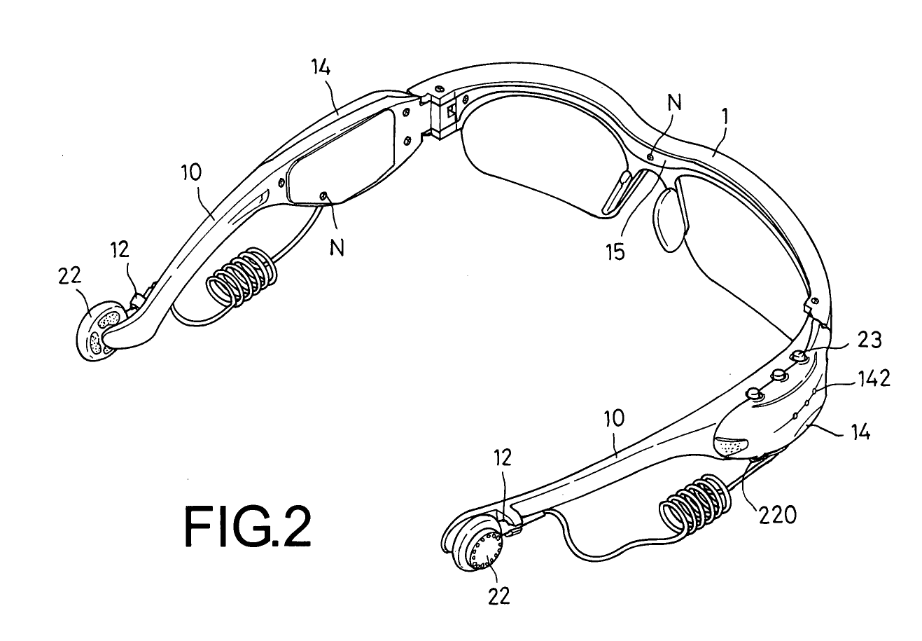

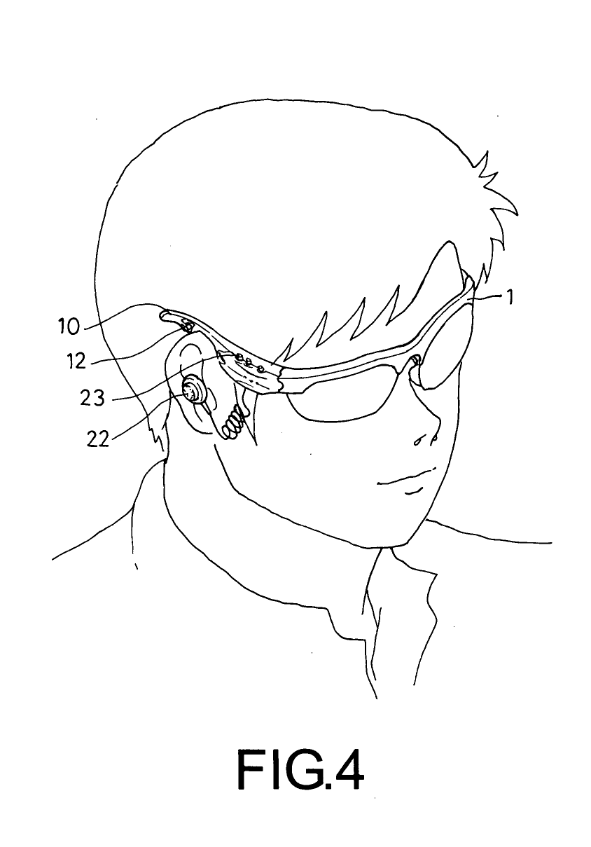

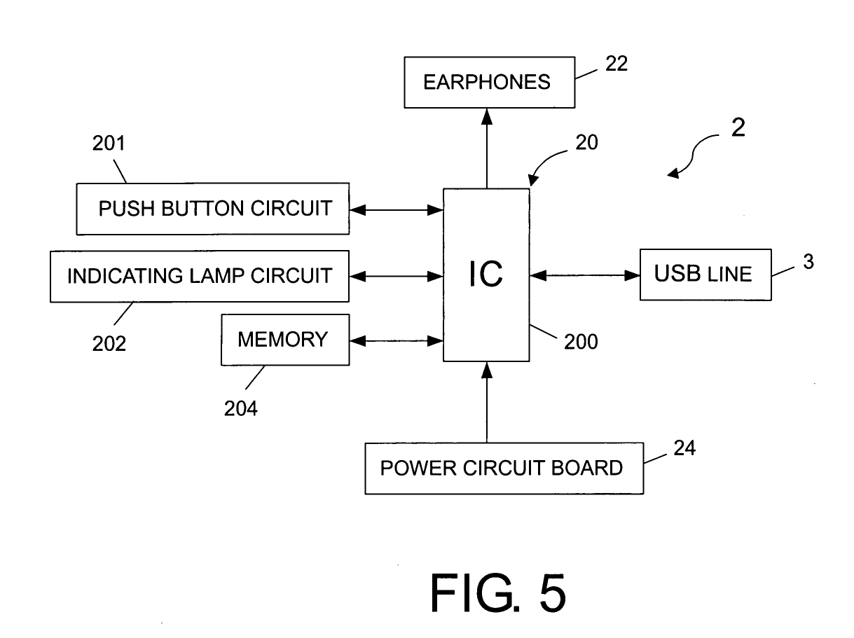

In using, as shown in FIGS. 2-5, to play a music by the music sounding device 2, music programs are first to be recorded in the memory 204 of the music sounding device 2, by firstly pulling out the plug 220 of the earphone 22, and then the first plug 30 of the USB line 3 is inserted in the jack 203 of the electric circuit board 20 and insert the second plug 31 of the USB line 3 in the USB jack of a computer to let the music programs in the computer sent to the IC 200 and recorded in the memory 204 of the music sounding device 2. After the music programs are finished in recording in the memory 204, then the first plug 30 of the USB line 3 is pulled out of the jack 203, and the second plug 31 removed from the USB jack of a computer. Then a wearer of the glasses releases the earphones 22 from the insert holes 12 and puts them in two ears, and the plug 220 is inserted in the jack 203 of the electric circuit board 20, pressing the push button 23 to turn on the music sounding device 2, then the IC 200 may operate to send music signals based on the music programs recorded in the memory 204 to the earphones 22, which can sounded out the music signals in the ears of the wearer.

If the wearer of the glasses does not use the music sounding device 2, he takes the earphones 22 off the ears, and inserted in the insert holes 12, only wearing the glasses 1 with the wires of the earphones 22 not to be entangled by anything.

While the preferred embodiment of the invention has been described above and it will be recognized that various modifications may be made therein and the appended claimed are intended to cover all such modifications may fall within the spirit and scope of the invention.

What is claimed is:

1. A pair of glasses with a music sounding device comprising:
a pair of glasses having two temples respectively provided with a chamber opening outward, and a cap closed on each said chamber;
a music sounding device installed in said chamber of said two temples and composed of;
an electric circuit board installed in said chamber of a first temple and provided with an IC circuit, a push button circuit, an indicating lamp circuit, an insert hole for a USB, and a memory; a power wire connected at a front side of said electric circuit board, said power wire hidden in said glasses;
a power circuit board installed in said chamber of a second temple, said power wire of said music sounding device connected with a front side of said power circuit board;
a battery placed in said chamber of said second temple and connected with a rear side of said power circuit board;
an earphone fixed at a rear side of said electric circuit board, another earphone connected with a rear side of said power circuit board;
a push button fixed on said electric circuit board and protruding out of said cap of said chamber;
a music program memorized in a computer being loaded through a USB line into said memory of said music sounding device at first, a wearer of said glasses pressing said push button for starting said music program recoded in said memory of said music sounding device, which then generates music signals of said music program and sends it to said two earphones, which then sounds out said music signal in the ears of the wearer of said glasses.

2. The pair of glasses with a music sounding device as claimed in claim 1, wherein said chamber of said first temple is provided with plural notches spaced apart in circumferential edge, and plural threaded rods protruding through a bottom wall.

3. The pair of glasses with a music sounding device as claimed in claim 1, wherein said two temples are respectively provided with a fitting hole bored in a protruding sidewise block near a rear end.

4. The pair of glasses with a music sounding device as claimed in claim 1, wherein said glasses are provided with an elongate groove extending in a bar on two lenses and reaching said chamber of said two temples respectively by two ends, a threaded hole is bored in a center portion of said bar under said elongate groove, and an elongate strip bored with a threaded hole is fitted tightly in said elongate groove with a screw engaging with said threaded hole of said bar and said elongate strip.

5. The pair of glasses with a music sounding device as claimed in claim 1, wherein said cap closed on said chamber of said first temple is provided with plural notches spaced apart around a circumferential edge and an indicating lamp fixed on a center portion.

6. The pair of glasses with a music sounding device as claimed in claim 1, wherein each said earphone is provided with a plug at its wire end, able to fit and be kept stably in a said fitting hole of said sidewise block each said temple, when said earphones are not used.

7. The pair of glassed with a music sounding device as claimed in claim 1, wherein a USB (universal serial bus) line is additionally provided, having a first plug to insert in a jack of said music sounding device and a second plug to insert in a USB jack of a computer for loading music programs memorized in said computer into said memory of said music sounding device of said glasses.
